(19) United States
(12) Patent Application Publication
(10) Pub. No.: US 2004/0263426 A1
(43) Pub. Date: Dec. 30, 2004

(54) Information processing device, window display control method and program

(75) Inventor: Masaya Endo, Ome-shi (JP)

Correspondence Address: PILLSBURY WINTHROP, LLP, P.O. BOX 10500, MCLEAN, VA, 22102, US

(73) Assignee: Kabushiki Kaisha Toshiba, Tokyo (JP)

(21) Appl. No.: 10/825,676

(22) Filed: Apr. 16, 2004

(30) Foreign Application Priority Data
Jun. 27, 2003 (JP) 2003-185314

(51) Int. Cl. G09G 5/00; G09G 5/02; G06F 15/16; G06F 15/167

(52) U.S. Cl. 345/2.2; 345/1.1; 345/2.1; 345/2.3; 345/156; 345/698; 709/202; 709/203; 709/216

(57) ABSTRACT

In an information processing device having a display control function which controls a plurality of display monitors in a multi-monitor environment, when a display screen, on which a window is displayed, controlled under the multi-monitor environment is moved from a first display monitor to a second display monitor, window display information on the display screen of the first display monitor is acquired as information which can be reproduced on the second display monitor, and the window display information is held.

### CROSS-REFERENCE TO RELATED APPLICATIONS

This application is based upon and claims the benefit of priority from prior Japanese Patent Application No. 2003-185314, filed Jun. 27, 2003, the entire contents of which are incorporated herein by reference.

### BACKGROUND OF THE INVENTION

1. Field of the Invention

The present invention relates to an information processing device, a window display control method and a program suitable for applying to an environment in which the application treating two or more display windows is executed.

2. Description of the Related Art

For instance, when the display resolution of the display monitor is changed from a high resolution to a low resolution, the display control of the window in the personal computer is performed as follows. Only when the resolution to be changed is lower than the displayed window, the size of the displayed window is changed not to extend off the screen by the OS. Moreover, the size change technology of the window for two or more display monitors is proposed (For instance, see Jpn. Pat. Appln. KOKAI Publication No. 2000-339130). In the technology, for instance, the window is selected one by one, and is expanded and displayed on the display screen for presentation.

The following problems are listed concerning a conventional window display control.

(1) Movement of the Window on the Digital Display Under the Multi-Monitor Environment

When the window displayed on the display monitor (monitor 1) is moved to another (for instance, an external) display monitor (monitor 2), the window displayed on the monitor 1 holds the window size before move and is displayed on the monitor 2. Therefore, the window extends off the monitor when the window is moved to the monitor 2 in a case that the window size displayed on the monitor 1 is larger than the screen resolution of the monitor 2. For instance, if the screen resolution of the monitor 1 is “1600×1200” (dots; hereinafter, the unit will be omitted) and the screen resolution of the monitor 2 is “1024×768”, when the window having the window size of “1280×10²⁴” displayed on the monitor 1 is moved to the monitor and is displayed thereon, the window extends off the screen of the monitor 2, and a part of the window is not displayed.

(2) Change in The Display Resolution at a Window Display State

As described above, when changing the display resolution of the display monitor from a high resolution to a low resolution, only in a case the changed resolution is lower than the displayed window, there is the technology in which the OS changes the size of the displayed window not to extend off the screen. In this case, when setting the display resolution of the monitor in a high resolution (returning to an original resolution) after the window size is changed, the window size is not changed and only the display resolution of the monitor is changed. Therefore, since the reduced size of the displayed window is remained, the user should change the window size to return the display resolution of the monitor to a state before change, and a complicated operation is required. For instance, when changing the display resolution of the monitor to “800×600” in a state that the window of “1024×768” displayed on the monitor by the display resolution of “1600×1200”, the size of the window is changed to “800×600” within the display resolution thereof. Thereafter, even when the display resolution of the monitor is returned to “1600×1200”, the window size remains “800×600” which has already been changed.

(3) Size Change by the Drag Operation of the Window when the Window is Displayed in the Window

When the size of window 1 is reduced by the drag operation in a state that, for instance, the plurality of windows (windows 1a, 1b, . . . ) are displayed in the window 1, windows 1a, 1b, . . . displayed therein are hidden along with size reduction of the window 1. This is similar that the number of windows in window 1 is one.

As mentioned above, when the window is moved between the display monitors having different display resolutions, various incompleteness, such that the window extends off the screen, and the window is not in a proper size etc., occurs.

### BRIEF SUMMARY OF THE INVENTION

An aspect of the present invention provides an information processing device, a window display control method and a program in which all of the opened windows can be displayed by always maintaining them in a proper size, for movement of the window between the display monitors, change of the screen resolution in a state that the window is opened, and the reduction operation of an outside window in a state that the window is displayed in the window, etc.

An information processing device having a display control function which controls a plurality of display monitors in a multi-monitor environment, according to the first aspect of the present invention is characterized by comprising: means for, when a display screen, on which a window is displayed, controlled under the multi-monitor environment is moved from a first display monitor to a second display monitor, acquiring window display information on the display screen of the first display monitor as information which can be reproduced on the second display monitor; and means for holding the window display information.

An information processing device according to the second aspect of present invention is characterized by comprising: means for controlling a plurality of display monitors in the multi-monitor environment; means for, when a display screen, on which a window is displayed, controlled under the multi-monitor environment is moved from a first display monitor to a second display monitor, acquiring at least the sizes of the display screen of the first and second display monitors, which are controlled under control of the means for controlling the plurality of display monitors, as a number of dots; and means for changing the sizes of all windows on the screen of the first display monitor in proportion to the size of the screen acquired by the means for acquiring the size, in which the second display monitor displays all windows changed by the means for changing the sizes.

An information processing device according to the third aspect of present invention is characterized by comprising: a display monitor; means for changing a resolution of the display monitor; means for acquiring a size of the screen of the display monitor as a number of dots when the means for changing the resolution changes the resolution of the display monitor; means for changing the size of all windows displayed on the display monitor in proportion to the size of the screen acquired by the means for acquiring the size; and means for displaying all of the windows, which is changed by the means for changing the sizes, on the display monitor.

An information processing device according to the fourth aspect of present invention is characterized by comprising: means for displaying a second window displayed in a first window; means for, when a size of the first window is changed while the second window displayed in the first window, calculating a ratio of the changed window size; and means for changing the size of the second window displayed in the first window at the rate calculated by the means for calculating the ratio and displaying the second window.

The present invention can be achieved as a window display control method and a computer program which have a function to achieve above-mentioned feature.

### BRIEF DESCRIPTION OF THE SEVERAL VIEWS OF THE DRAWING

FIG. 1 is a block diagram which shows a configuration of an information processing device in the embodiment of the present invention;

FIG. 2 is a figure which shows a state transition according to the first embodiment of the present invention;

FIG. 3 is a flow chart which shows a processing procedure in the first embodiment of the present invention;

FIG. 4 is a flow chart which shows a processing procedure in the first embodiment of the present invention;

FIG. 5 is a figure which shows a state transition according to the second embodiment of the present invention;

FIG. 6 is a flow chart which shows a processing procedure in the second embodiment of the present invention;

FIG. 7 is a figure which shows a state transition according to the third embodiment of the present invention; and

FIG. 8 is a flow chart which shows a processing procedure in the third embodiment of the present invention.

### DETAILED DESCRIPTION OF THE INVENTION

Hereinafter, the embodiment of the present invention will be explained referring to the drawings.

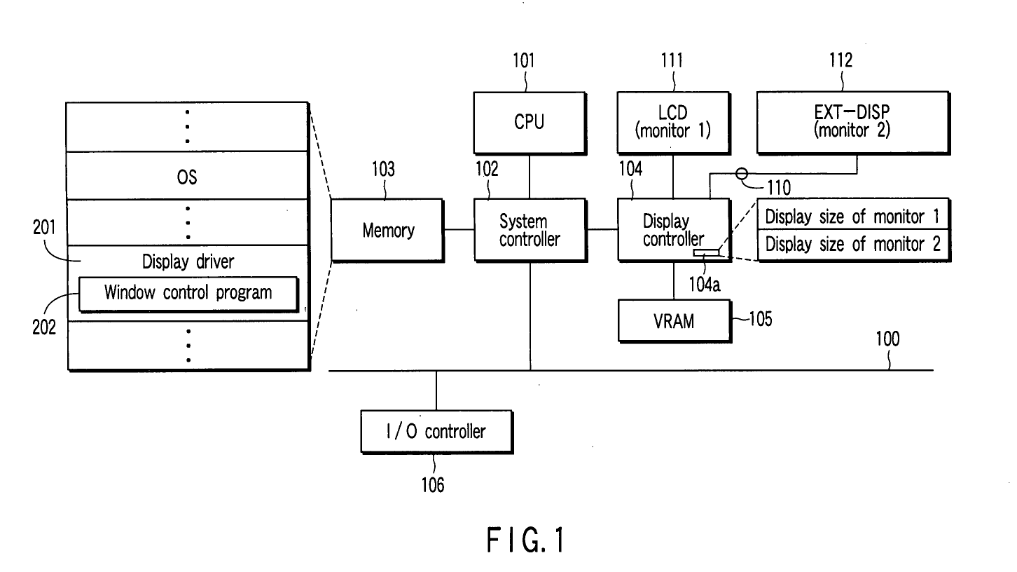

FIG. 1 is a block diagram which shows a configuration of the information processing device according to the first embodiment of the present invention.

The information processing device shown in FIG. 1 comprises a CPU 101, a system controller 102, a memory 103 used as a main memory, a display controller 104, a video RAM (VRAM) 105, an input/output (I/O) controller 106, an internal display device (LCD) 111, and a system bus 100, etc.

The display controller 104 has an external display monitor connector 110. The display controller 104 is connectable with the external display device (EXT-DISP) 112 via an external display monitor connector 110. With this configuration, the display control function in the multi-monitor environment can be provided.

The CPU 101 is a processor provided to control the operation of the information processing device, and executes an operating system (OS), various application programs, and utility programs. The operating system (OS) comprises the display control function for controlling the internal display device 111, and the external display device 112 connected with external display monitor connector 110.

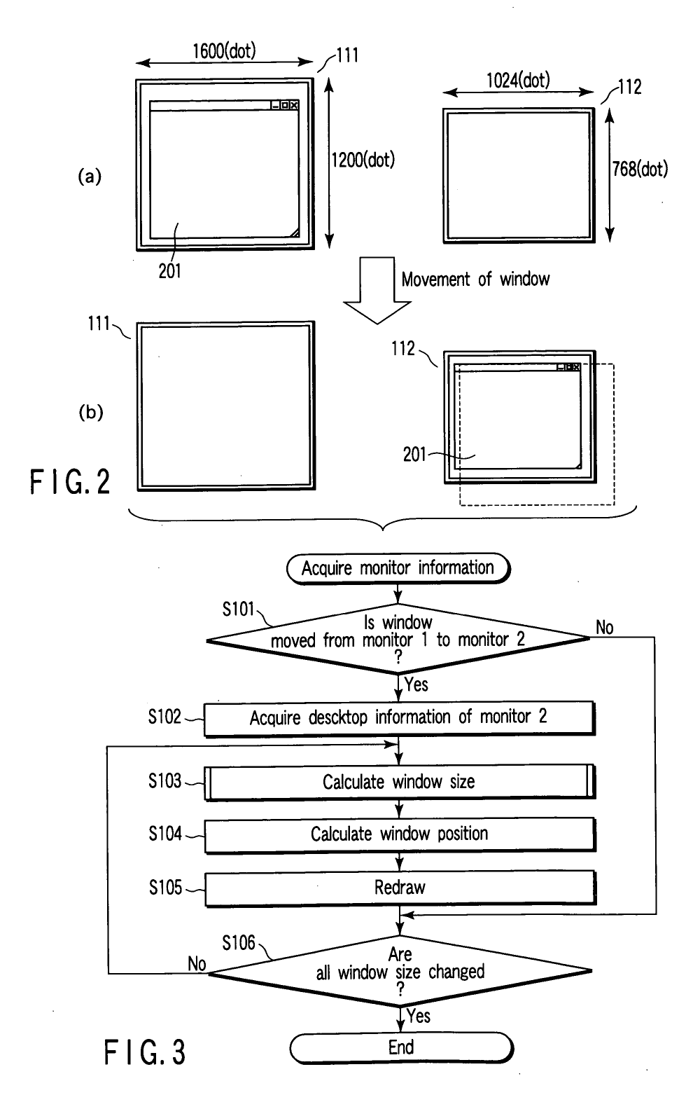

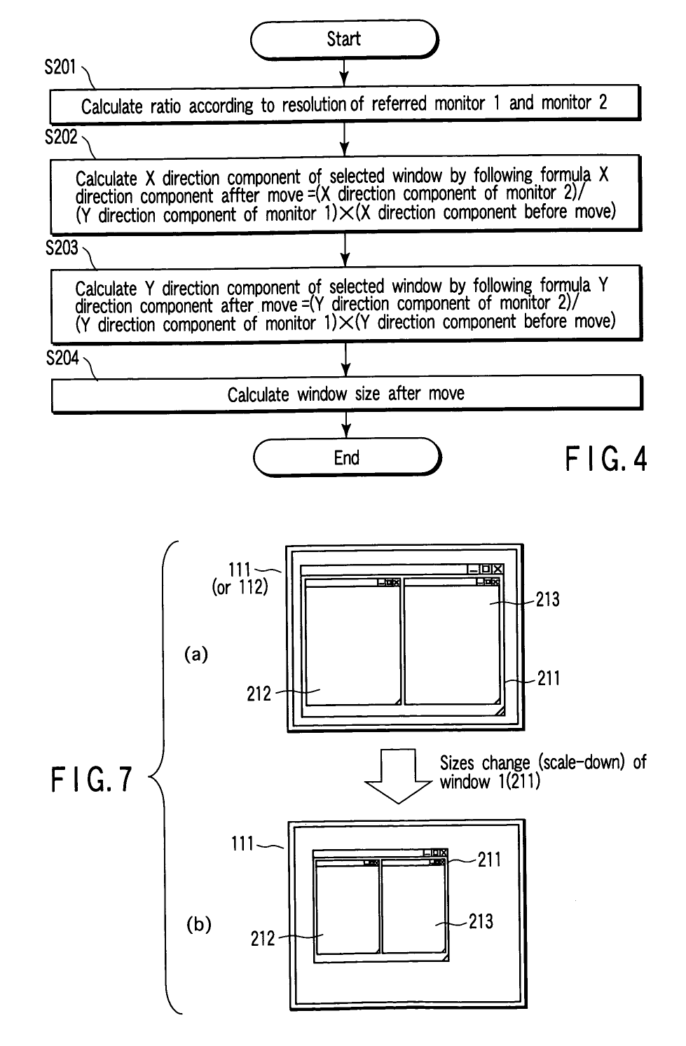

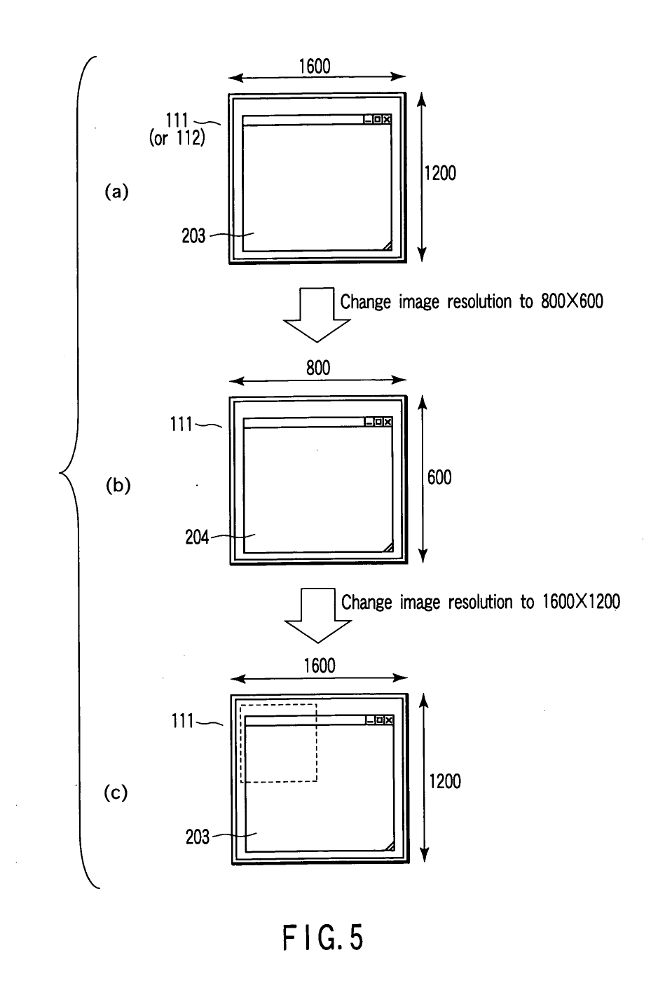

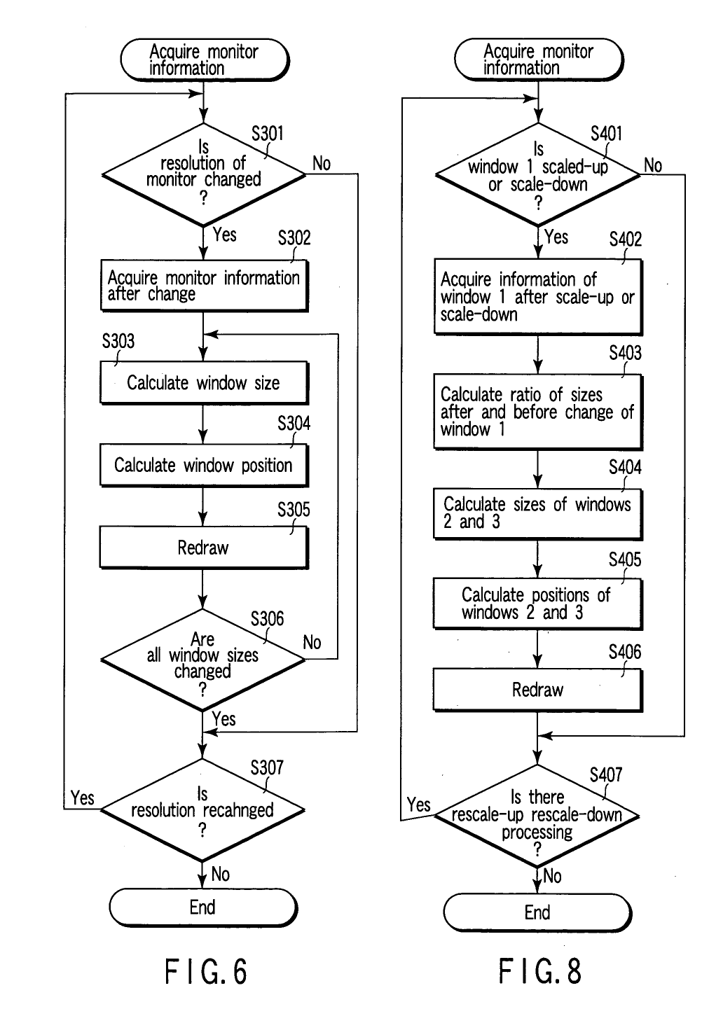

The memory 103 comprises a program area where the operating system (OS), various application programs, and utility programs, etc. are stored, and a RAM area used to execute each program and perform processing. The display driver 201 comprises a window control program 202 in the program area. The processing procedure of the window control program 202 provided to the display driver 201 is shown in FIG. 3, FIG. 4, FIG. 6, and FIG. 8, and the processing function will be described later referring to FIG. 2, FIG. 5, and FIG. 7. In addition, the RAM area holds of the display window information etc., which contain the window size used by the above-mentioned window control program 202 under the control of the OS, and the display window information etc. are referred by the window control program 202.

The system controller 102 is a bridge device which connects between the local bus of the CPU 101 and the system bus 100. The system controller 102 incorporates the memory controller to control the memory 103.

The display controller 104 controls the internal display device 111 and the external display device 112 and achieves the display control function in the multi-monitor environment. To achieve this display control function, the display controller 104 comprises a display screen configuration register 104a, which holds each display screen size as the number of dots of an internal display device 111 and an external display device 112, which is connected with the external display monitor connection part 110. In addition, the display controller 104 has a function of developing the display image data to be displayed on each of above-mentioned display devices 111 and 112 on the video RAM (VRAM) 105 and transmitting it to each of above-mentioned display devices 111 and 112.

The I/O controller 106 performs an I/O control of various I/O devices such as a pointing device and a communication module which are connected on the system bus 100, for instance.

Referring to FIG. 2 to FIG. 8, the window display control function in the first to third embodiments of the present invention will be explained.

First, the first embodiment of the present invention will be explained referring to FIG. 2 to FIG. 4. In the first embodiment, the above-mentioned problem is solved at a movement of the window on a digital display under the multi-monitor environment.

FIG. 2 shows the state transition to explain the window display control function in the multi-monitor environment intended for the internal display device 111 and the external display device 112 in the first embodiment of the present invention. FIG. 3 and FIG. 4 show the flowchart of the processing of the window control program 202 in the first embodiment of the present invention.

In the first embodiment, in two display devices (the internal display device 111 and the external display device 112) under the multi-monitor environ-ment, for instance, the screen resolution of the internal display device 111 (called as a “monitor 1”, here) is assumed to be “1600×1200”, and the screen resolution of the external display device 112 (called as a “monitor 2”, here) is assumed to be “1024×768”.

Here, when the window 201 (for instance, 1280×960) to be moved, which is displayed on the screen of the monitor 1, is moved to the screen of the monitor 2 (step S101 Yes of FIG. 3), first, the display size information of the monitor 1 and the monitor 2 are acquired from the display screen configuration register 104a of the display controller 104 (step S102 of FIG. 3).

Next, the window size after movement of the target window 201 (1280×960) is calculated according to the ratio of the resolutions of the monitor 1 and monitor 2 (step S103 of FIG. 3).

As the calculation of this window size, first, the ratio of each resolution of the monitor 1 (1024×768) and each resolution of the monitor 2 (1600×1200) is calculated (step S201 of FIG. 4).

Consequently, the X-direction component (number of dots along horizontal direction) after moving the target window 201 to be moved is calculated by the expression shown in FIG. 4 (step S202 of FIG. 4). The Y-direction component (number of dots along vertical direction) after moving the target window 201 to be moved is calculated by the expression shown in FIG. 4 (step S203 of FIG. 4). As a result, the display window size displayed on the monitor 2 is calculated (step S204 in FIG. 4).

In the above-mentioned example, when the window 201 of “1280×960” (80% of the display screen of the monitor 1 is occupied) displayed on the monitor 1 is moved to the monitor 2, the size of the window 201 is changed to the size of “819×614” (80% of the display screen of the monitor 2 is occupied) according to the above-mentioned resolution ratio.

The display position (x0, y0) of the window is changed based on the above-mentioned calculated ratio after the window size after movement is calculated (step S104 of FIG. 3).

The window 201 displayed on the monitor 1 is redrawn and is displayed on the monitor 2 based on the window size after movement obtained by the above-mentioned calculation and the display position of the corresponding window. In this case, it is of course that the image inside the window before move is maintained.

The state transition of this window is shown in FIG. 2. The broken line shown in (b) of FIG. 2 shows a state the change processing of the window size is not preformed after movement of the window.

The above-mentioned window size changing processing (S103-S106) is performed for all windows displayed on the monitor 1. As a result, the movement processing of the above-mentioned window ends (step S106 Yes of FIG. 3). The flowchart shown in FIG. 3 is the window size changing processing when the window moves from the monitor 1 to the monitor 2. The explanation of the change processing of the window size will be omitted when the window moves from the monitor 2 to the monitor 1, because the processing thereof is similar to the above-mentioned processing.

As mentioned above, in the first embodiment, even when the window size to be moved exceeds the resolution of “1024×768” of the monitor 2, the window is displayed without extends off the monitor 2 (without missing part and being displayed).

Next, the second embodiment of the present invention will be explained referring to FIG. 5 and FIG. 6. In the second embodiment, the above-mentioned problem at change of the display resolution is solved when the window is displayed.

FIG. 5 shows the display state transition of the window according to the change in the screen resolution in the second embodiment of the present invention. FIG. 6 shows the flowchart according to the processing of the window control program 202 in the second embodiment of the present invention.

FIG. 5 shows an example of changing (switching) the screen resolution of the internal display device 111 such as “1600×1200”→“800×600”→“1600×1200”.

When the screen resolution of the internal display device 111 is changed from “1600×1200” to “800×600” in a state that the window 203 is displayed on the internal display device 111 (step S301 Yes of FIG. 6), the screen resolution is acquired (step S302 of FIG. 6).

Next, according to the ratio of the acquired screen resolution, the size of the window 203 before change displayed on the internal display device 111 (assumed to be 1024×768, here) is changed to the target window size (512×384) of the window 204 to be changed (step S303 of FIG. 6). The concrete explanation will be omitted, because the calculation of this window size is almost similar to the calculation of the window size in the above-mentioned first embodiment.

Next, the display position on the screen of the window 204 to be changed is calculated according to changing in the window size (step S304 of FIG. 6).

The window is re-drawn based on the window size obtained by the above-mentioned calculation after moving and the corresponding window display position. As a result, the window 203 (1024×768) is changed to the window 204 (512×384) and is displayed thereon.

The change processing of such a window size is performed to all windows displayed on the internal display device 111 (step S306 of FIG. 6).

Here, when the screen resolution is returned to the former resolution for instance, the change processing of the size of the window based on the ratio of the screen resolution before change and the screen resolution after change similar to above-mentioned description is performed (step S307 of FIG. 6).

The state transition of the window size according to the change in the display resolution in this state of the window display is shown in FIG. 5. The broken line shown in (c) of FIG. 5 shows the state of the window when the above-mentioned change processing of the window size is not performed.

In the example shown in this FIG. 5, when the window 203 displayed with the screen resolution of “1600×1200” is changed to the screen resolution of “800×600” on the display screen of the internal display device 111, the window 203 having the size of “1024×768” is dynamically changed into the window 204 having the size of “512×384” according to the change thereof. Thereafter, when the screen resolution is changed to “1600×1200” again (returning to the original screen resolution), in the second embodiment, the window 204 having the size of “512×384” is dynamically changed to the window 203 having the size of “1024×768” again (returning to the original one). The broken line shown in (b) of FIG. 5 shows the state after the image resolution is changed when the change processing of the window size is not performed.

Next, the third embodiment of the present invention will be explained referring to FIG. 7 and FIG. 8. In the third embodiment, the above-mentioned problem caused by the size change of the window when the window is displayed on the window (drag operation) is solved.

FIG. 7 shows the display state transition of the window according to the size change of the window by the drag operation in the third embodiment of the present invention. FIG. 8 shows a flowchart according to the processing of the window control program 202 in the third embodiment of the present invention.

In a state that a plurality of windows 212 (window 2) and 213 (window 3) are displayed in the window 211 (called as “window 1” here) in the internal display device 111, when the window 1 is reduced by the drag operation (Yes in step S401 of FIG. 8), the changing rate of the window size according to the reduction operation is calculated (step S402 of FIG. 8 and S403). The size of each of windows 2 and 3, whose sizes are reduced, in the window 1 is calculated by using the calculated changing rate (step S404 of FIG. 8). In addition, the display position on the screen of each of windows 2 and 3 whose sizes are changed by using the changing rate is calculated (step S405 of FIG. 8).

The windows 2 and 3 are re-drawn based on the window size after change obtained by the above-mentioned calculation and the corresponding display position (step S406 of FIG. 8). Such processing is repeatedly executed for every change operations by the drag operation of the window 1 (step S407 of FIG. 8).

As a result, when the size of window 1 is reduced by the drag operation while the windows are displayed in the window 1, since the windows displayed in window 1 are also reduced according to the reduction of the size of the window 1, the inconvenience of hiding the windows displayed in the window 1 according to the reduction operation of window 1 can be prevented.

In each of above-mentioned embodiments, the program, which achieves each processing function in the first to third embodiments, is stored in the window control program 202 in the display driver 201, respectively. It is not to be limited to this. The program may be provided to the display controller 104 etc., for instance. Moreover, it is also possible to treat the window control program 202 in the display driver 201 achieving each above-mentioned embodiment as a software unit in each processing of each embodiment.

As mentioned above, according to the embodiments of the present invention, all of the opened windows can be displayed by always maintaining them in a proper size, for movement of the window between the display monitors, change of the screen resolution in a state that the window is opened, and the reduction operation of an outside window in a state that the window is displayed in the window, etc.

Therefore, since the embodiment of the present invention changes dynamically the window size by matching it to the display resolution of the monitor, a proper window display can be always maintained.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. An information processing device having a display control function which controls a plurality of display monitors in a multi-monitor environment, the information processing device comprising:
means for, when a display screen, on which a window is displayed, controlled under the multi-monitor environment is moved from a first display monitor to a second display monitor, acquiring window display information on the display screen of the first display monitor as information which can be reproduced on the second display monitor; and
means for holding the window display information.

2. The information processing device according to claim 1, wherein the window display information includes
at least size and position information of all windows displayed on the display screen of the first display monitor,
a display resolution of the first display monitor, and
a display resolution of the second display monitor.

3. An information processing device comprising:
means for controlling a plurality of display monitors in the multi-monitor environment;
means for, when a display screen, on which a window is displayed, controlled under the multi-monitor environment is moved from a first display monitor to a second display monitor, acquiring at least the sizes of the display screen of the first and second display monitors, which are controlled under control of the means for controlling the plurality of display monitors, as a number of dots; and
means for changing the sizes of all windows on the screen of the first display monitor in proportion to the size of the screen acquired by the means for acquiring the size, wherein
the second display monitor displays all windows changed by the means for changing the sizes.

4. An information processing device comprising:
a display monitor;
means for changing a resolution of the display monitor;
means for acquiring a size of the screen of the display monitor as a number of dots when the means for changing the resolution changes the resolution of the display monitor;
means for changing the size of all windows displayed on the display monitor in proportion to the size of the screen acquired by the means for acquiring the size; and
means for displaying all of the windows, which is changed by the means for changing the sizes, on the display monitor.

5. An information processing device comprising:
means for displaying a second window displayed in a first window;
means for, when a size of the first window is changed while the second window displayed in the first window, calculating a ratio of the changed window size; and
means for changing the size of the second window displayed in the first window at the rate calculated by the means for calculating the ratio and displaying the second window.

6. A window display control method comprising:
acquiring at least the sizes of the display screen of the first and second display monitors, which are controlled under control of the means for controlling the plurality of display monitors, as a number of dots, when a display screen, on which a window is displayed, controlled under the multi-monitor environment is moved from a first display monitor to a second display monitor at a time when a plurality of display monitor are displayed in a multi-monitor environment;
changing all the sizes of the windows on the screen of the first display monitor in proportion to the size of the screen acquired by the means for acquiring the size; and
displaying all changed windows on the second display monitor.

7. A window display control method comprising:
acquiring a size of a screen of a display monitor as a number of dots when a resolution of the display monitor is changed;
changing the size of all windows displayed on the display monitor in proportion to the acquired size of the screen; and
displaying the size-changed windows on the display monitor.

8. A window display control method comprising:
when a size of a first window is changed while a second window displayed in the first window, calculating a ratio of the changed window size; and
changing the size of the second window displayed in the first window with the size at the calculated rate and displaying the second window.

9. A computer program for controlling a plurality of display monitors in a multi-monitor environment, the program being stored in a computer readable medium, and the program comprising:
acquiring at least the sizes of the display screen of the first and second display monitors, which are controlled under control of the means for controlling the plurality of display monitors, as a number of dots, when a display screen, on which a window is displayed, is moved from a first display monitor to a second display monitor at a time when a plurality of display monitor are displayed in a multi-monitor environment;
changing all the sizes of the windows on the screen of the first display monitor in proportion to the size of the screen acquired by the means for acquiring the size; and
displaying all changed windows on the second display monitor.

10. A computer program for controlling a plurality of display monitors in a multi-monitor environment, the program being stored in a computer readable medium, and the program comprising:
acquiring a size of a screen of a display monitor as a number of dots when a resolution of the display monitor is changed;
changing the size of all windows displayed on the display monitor in proportion to the acquired size of the screen; and
displaying all of the size-changed windows on the display monitor.

11. A computer program for controlling a plurality of display monitors in a multi-monitor environment, the program being stored in a computer readable medium, and the program comprising:
when a size of a first window is changed while a second window displayed in the first window, calculating a ratio of the changed window size; and
changing the size of the second window displayed in the first window with the size at the calculated rate and displaying the second window.
